(19) United States
(12) Patent Application Publication
(10) Pub. No.: US 2005/0120598 A1
(43) Pub. Date: Jun. 9, 2005

(54) Limited constituency advertising calendar

(76) Inventor: Thomas W. Bury, College Park, MD (US)

Correspondence Address: William S. Ramsey, 5253 Even Star Place, Columbia, MD, 21044, US

(21) Appl. No.: 11/041,397

(22) Filed: Jan. 24, 2005

Related U.S. Application Data
(63) Continuation-in-part of application No. 10/638,765, filed on Aug. 11, 2003.

(30) Foreign Application Priority Data
Aug. 10, 2004 (WO) PCT/US04/25824

(51) Int. Cl. G09D 3/04

(52) U.S. Cl. 40/119; 40/121

(57) ABSTRACT

This invention is a method of producing a calendar containing advertisements by suppliers and distributors, both of which are members of a limited constituency. The calendars are for the use by customers of the distributors, who typically are retailers. The advertisements of the suppliers feature product information and promotional offerings of the suppliers who are identified only by identification symbols such as numbers. The advertisements of the distributors, who distribute items manufactured by the suppliers, feature accessible information allowing contact with the distributors and may include promotional offers. The distributors provide their customers, typically retailers, with the calendars and take orders for items listed by the advertisers and others

### CROSS-REFERENCE TO RELATED APPLICATIONS

This is a continuation-in-part application which claims priority to U.S. Ser. No. 10/638,765, filed Aug. 11, 2003 and PCT/US04/25824, filed Aug. 10, 2004.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention

This invention relates to the production and distribution of calendars.

2. Description of Related Art Including Information Disclosed Under 37 CFR 1.97 and 37 CFR 1.98

Embodiments of this invention are methods of producing a calendar containing advertisements by suppliers and distributors, both of which are members of a limited constituency. The calendars are for the use by customers of the distributors, who typically are retailers. The advertisements of the suppliers feature product information and promotional offerings of the suppliers who are identified only by identification symbols such as numbers. The advertisements of the distributors, who distribute items manufactured by the suppliers, feature accessible information allowing contact with the distributors and may include promotional offers. The distributors provide their customers, typically retailers, with the calendars and take orders for items listed by the advertisers and others.

U.S. Pat. No. 5,106,122 discloses a combination calendar and catalogue in which information on the products depicted on the calendar is provided. Tabs at the bottom or edge of the calendar are attached to product information sheets and provide convenient access to specific products and ordering information.

U.S. Pat. No. 5,316,342 discloses a calendar with space for a child to add art on each of the 12 months and means for attaching the calendar to a refrigerator. The space for original art work covers at least half of the area of each page.

U.S. Pat. No. 6,186,553 discloses a theme calendar which the customer may customize with personal information and interests. The calendar may start and stop on individualize chosen dates and may include customized entries for each day.

U.S. Pat. No. 6,536,965 discloses a calendar producing system in which a user selects from a variety of pictures for the calendar, prints the calendar, and provides special indications for certain days as selected by the user. The calendar can be ordered and produced throughout the year.

Published Patent Application U.S. 2001/0032133 discloses a system for message delivery in which message companies provide ads and content companies provide content, the message is sent through the internet and received by the individual members of the audience.

Published Patent Applications U.S. 2001/0051901 discloses a method for linking retailer and database and consumer. The consumer can determine the product availability, view discounts and specials, and plan its visit to the retail store.

Published Patent Applications U.S. 2002/0052775 discloses a system for developing and implementing a multi-activity marketing plan.

Published Patent Applications U.S. 2002/0114220 discloses a calendar which is provided by a business which uses regular appointments, such as beauty parlor or dentist. The calendar includes ads, the appointment dates, information on the business, and would be designed to cover the period of time between appointments.

The prior art does not disclose the advantages of the present invention, which provides a method of producing and manufacturing a calendar for distribution by a limited constituency. The advertisers featuring product information and promotional offerings and the distributors, who distribute items manufactured by the advertisers, both are members of the limited constituency. The distributors provide retailers with the calendars and take orders for items listed by the advertisers and others.

### BRIEF SUMMARY OF THE INVENTION

The process of producing calendars in which both the suppliers who advertise in the calendars and the distributors of the calendars to customers are both members of a limited constituency. The customers are not members of the limited constituency. The process comprises the following steps. The calendar producer solicits advertisements and suppliers' promotional offers from suppliers who are members of a limited constituency. In addition, an advertisement is solicited from a distributor who is a member of the limited constituency. The order of the first two steps is not important. The next step is combining the advertisements and suppliers' promotional offers into printed calendars. The calendars are then printed. The calendars comprise accessible information about the distributor and only identifying symbols about the suppliers. The printed calendars then are sold to the distributor who is a member of the limited constituency. The calendars are then distributed by the distributor to retailers who are termed “customers” in this patent application, who use the advertisements in selecting the products advertised by the suppliers. The customers then provide their patrons (termed “users”) with the promotional specialty items which are customized with the customer's logo, name, address, telephone number, website, e-mail address, etc.

The objective of this invention is to provide a method for manufacturing calendars with advertising of supplier's products and distributor's services.

Another objective is to provide calendars with both advertisements from suppliers and a distributor and with promotional offers from suppliers and or the distributor.

Another objective is to provide a method of producing calendars containing advertising of suppliers' products without providing information which allows direct contact with the suppliers while bypassing the distributor who provided the calendar.

Another objective is to provide calendars which provide means for evaluating their efficiency through tracking promotional offers.

Another objective is to provide a method of producing calendars with advertising themes based on the changing seasons and holidays.

Another objective is to provide a method of producing calendars inexpensively, efficiently, and without adverse effects on the environment.

### BRIEF DESCRIPTION OF THE SEVERAL VIEWS OF THE DRAWING

FIG. 1 is a plan view of a representative calendar designed by this invention

FIG. 2 is a flow chart of one embodiment of the process of making and distributing the calendars of the present invention.

FIG. 3 is a plan view of a representative calendar showing a product planner sheet.

FIG. 4 is a plan view of a representative calendar showing a distributor product planner sheet.

FIG. 5 is a plan view of a representative calendar showing a detachable coupon sheet.

FIG. 6 is a plan view of a representative calendar showing a detachable return envelope.

FIG. 7 is a plan view of a representative calendar showing a storage envelope.

FIG. 8 is a plan view of a representative calendar showing a date sheet with a tickler.

FIG. 9 is a plan view of a representative calendar showing general information pages.

### DETAILED DESCRIPTION OF SOME EMBODIMENTS OF THE INVENTION

In this patent application the term “restricted constituency” means an organization restricted to suppliers and distributors in a single industry. “Accessible information” means information used by a consumer to identify and communicate with a seller, such as business name, address, telephone number, website address, and e-mail address. “Identifying symbols” means symbols such as numbers and list names or pseudonyms used by members of a restricted constituency to identify each other but which are not generally known by the general public or customers of members of the restricted constituency. “Promotional offers” means coupons or certificates which offer reduced prices or additional items to the end user making a purchase. Promotional offers may be offered by suppliers or by distributors. “Promotional specialty items” means useful items such as pens, letter openers, balloons, etc. which are customized with the customer's identification information, such as name, logo, address, telephone, fax, and e-mail numbers, and website addresses. The term “supplier” is used to designate a manufacturer or wholesaler who customizes the promotional specialty items. The term “distributor” means a person or organization who accepts orders from customers along with the customized identification material to be placed on the promotional specialty items, transmits the order to the supplier, and provides the customer with the customized promotional specialty items. The term “customer” or “retail customer” means the person or organization who desires promotional specialty items customized with the customer's identification information, such as name, logo, address, telephone, fax, and e-mail numbers, and website addresses. Customer's, who often have retail or service organizations, typically distribute the customized promotional specialty items gratis or as nominal cost to the customer's patrons, termed “users” in this patent application.

Some examples of limited constituency organizations include the Advertising Specialty Institute (ASI) and the Promotional Products Association International (PPAI). Quick Technologies Inc., Dallas Tex., owns a proprietary limited constituency association.

Limited constituency organizations will be further described using ASI as an example. ASI members are suppliers and distributors of promotional specialty items. Promotional specialty items are typically are custom imprinted with accessible information about the retailer. Promotional specialty items typically are distributed by a retailer to a customer on a free or nominal cost basis. Suppliers manufacture or obtain the promotional specialty items and imprint the items with the retailer's accessible information. The distributors deal with the retailers in obtaining orders for the items, providing the supplier with the accessible information for imprinting on the items, and distributing the items to the retailers.

Each member of a limited constituency is assigned a unique identifying symbol. The symbol does not contain accessible information, but may be used by members of the limited constituency to obtain accessible information about the assignee of the identifying symbol. The use of numbers as identifying symbols is termed a Registered numbering system. Pseudonyms used as identifying symbols are termed line names. Each member of ASI is assigned an unique number termed an ASI number.

Members of the limited constituency such as ASI are free to buy and sell to anyone. In fact, one of the requirements for membership in ASI of a nonmember distributor is demonstration of a number of invoices showing purchases from ASI member suppliers. This demonstrates that the candidate member distributor is a bona fide active distributor in the promotional specialty product industry.

In promotional and advertising material authorized by or sponsored by a limited constituency, and typically supplied to a retail customer by a distributor, the suppliers are identified only by identifying symbol. The distributor is identified by accessible information. This insures that a customer will process his or her order through the distributor rather than dealing directly with the supplier for the promotional specialty items.

### EXAMPLE 1

Example 1 is one embodiment limited constituency calendar. In this example, the suppliers manufacture and personalize promotional specialty goods. Such goods, such as pens, pencils, envelope openers, hats, mouse pads, etc., are items which are personalized with a retail customer's identification material, such as name, address, telephone number, website, e-mail address. The promotional goods are distributed to patrons of the retail customer free or at a nominal charge, and are considered part of the retail customer's marketing program.

The distributor solicits the retail customers through sales calls, catalogues, and calendars. Both the suppliers and the distributor are members of a limited constituency organization. The retail customer is not a member of the limited constituency organization.

The calendar of this example has 12 primary advertisements featuring the products of 12 suppliers. Each primary advertisement has a seasonal theme based on the month of the year the advertisement is associated with. Each primary advertisement features products manufactured by the supplier which fit with the seasonal theme, and may include other products of the supplier. The primary advertisements also may include promotional offers, such as coupons which may be used by the retail customer to obtain the products of the supplier at a reduced price when an order is placed with the distributor. Such promotional offers may include coupons with calendar specific tracking codes which allow the supplier a reliable means for assessing the effectiveness of the calendar advertisement. In an alternative configuration, several suppliers would share the primary advertisements associated with one month. The primary advertisements do not include accessible information which would allow the retail customer to contact the supplier, but includes only identification symbols which allows the distributor to identify and contact the suppliers.

The primary advertisements may include website information leading to a retail customer-friendly website on an international computer network. Such a website contains additional product information which may include products not described on the calendar. The website does not include accessible information which would allow the retail customer to order directly from the supplier. There are instructions and accessible information which allows a retail customer to contact his or her distributor, the distributor who supplied the calendar to the retail customer, to make an order. Alternatively, a website may include a list of distributors who are members of the restricted constituency along with accessible information which will enable the retail customer to contact the distributors and submit an order for promotional specialty items. For example, the website may provide information on distributors by geographic location throughout the country for use by retail customers. In another embodiment the website will not have any accessible information concerning the distributor. In this case the retail customer will rely on the calendar for accessible information concerning the distributor.

TABLE 1

| Month | Theme | Promotional Specialty Items |
|---|---|---|
| January | New Year | Champagne Glasses. |
| February | Valentine Day | Candy |
| March | Change of Seasons | Sports Items |
| April | Golf | Tees |
| May | Memorial Day | Flags |
| June | Summer Begins | Sunblock |
| July | 4th of July | Travel Items |
| August | Back to School | Pens |
| September | Back to Work | Desk items |
| October | Halloween | Safety items for children |
| November | Thanksgiving | Recognition Awards |
| December | Holidays | Food |

Each calendar of this example also will have an advertisement by a single distributor. The distributor's advertisement will include accessible information which will allow the retail customer, to contact the distributor. The distributor's advertisement also may include promotional offers which will encourage a retail customer to place an order with that distributor.

In this example, the distributor will provide his or her customers with calendars at no charge. The distributor takes orders from his or her retail customers; typically retailers or service providers who wish to obtain personalized items for distribution to users on a gratis or nominal charge basis. The distributor orders the personalized items from the supplier who customizes the items with the retail customer's information. The customized items are delivered to the retail customer either direct from the supplier or via the distributor

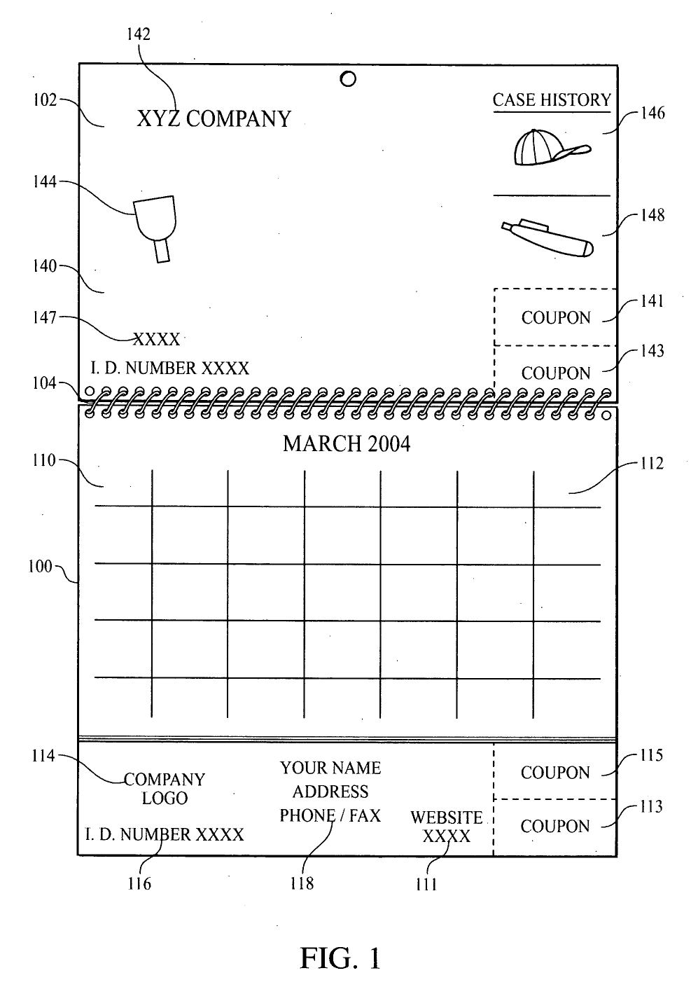

FIG. 1 is a plan view of a representative calendar designed by this invention. In this embodiment, the calendar 100 is in two primary parts, the primary advertisement 102 sheet which has a hole for hanging the calendar. The first month primary advertisement 140 is printed on the first sheet. A collection, typically 12-14 of date sheets 110 are bound by a spiral binding 104. The date sheets contain the information 112 normally found on a calendar sheet which covers one month, as well as information on special days, space for notations by the calendar users, etc. The second month primary advertisement is printed on the back of the first month date sheet. The second (and subsequent) month primary advertisements typically will contain information concerning a different supplier from that of the first primary advertiser.

The primary advertisement features the supplier's name 142, a primary product advertisement 144, secondary product advertisements 146 and 148, and promotional offers 141 and 143. An identification symbol 145 is used to enable a customer to identify the supplier to a distributor when the customer wishes to place an order. A retail customer-friendly website 147 may be included to allow a retail customer to obtain additional information on products. No accessible information which would allow the retail customer to place an order directly with the supplier is included on the primary advertisement or on a retail customer-friendly website.

One example of a retail customer-friendly website would have an introductory page with logos for the 12 suppliers who are the primary advertisers in the calendar. Clicking on a supplier logo would display pages with more information on products featured in the calendar ads and information on additional products of the supplier not featured on the calendar. In addition, printable promotional coupons which the retail customer may present for redemption to the distributor for promotions involving the supplier's products may be included on the website. The distributor then will present the redeemed coupon to the supplier when submitting the retail customer's order to the supplier.

The last page of the calendar is a hang sheet 114 which extends below the date sheets and is visible to the user throughout the year. The hang sheet features accessible data on the distributor such as name, address, telephone, fax, e-mail numbers 118, distributor's company logo 119, website address 111, and promotional offers 113 and 115. In addition, the limited constituency identification symbol 116 of the distributor is included.

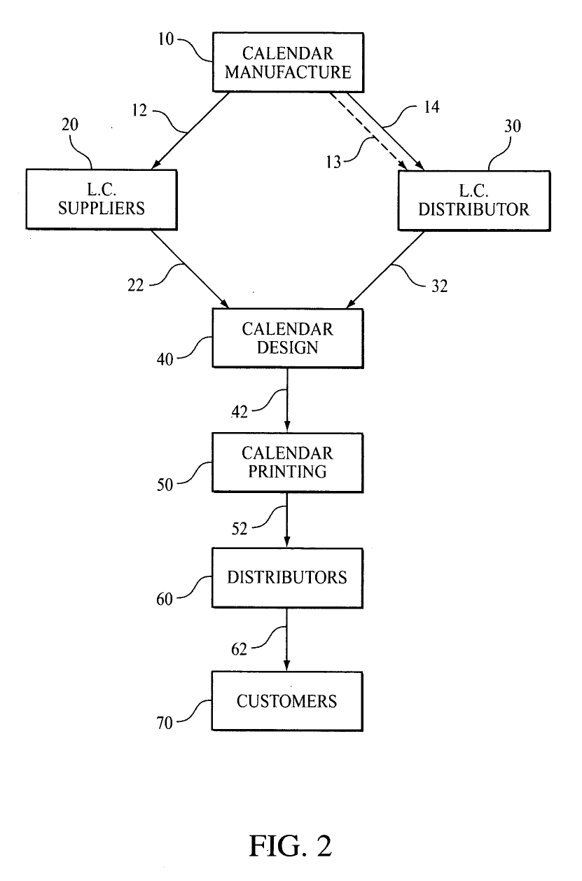

FIG. 2 is a flow chart of the process of making and distributing the calendars of the present invention.

The process begins when the calendar manufacturer 10 solicits advertisements 12 from several suppliers 20 all of whom are members of a limited constituency organization. The calendar manufacturer 10 also solicits an advertisement 14 from a single distributor 30 who also is a member of the limited constituency organization. Optionally, the calendar manufacturer 10 also solicits a retail customer-friendly website 13 from a that distributor 30 who also is a member of the limited constituency organization. The order of the solicitations in steps 12, 13 and 14 is not important.

Advertisement and promotional offer information from the suppliers are communicated 22 by the supplier to the calendar manufacturer for the process of calendar design 40. A typical supplier advertisement would be on a sheet facing a month's calendar and would include a number of advertisements from a supplier who is identified only by identification symbol. Alternatively, more than one supplier would share the advertisements for a month. Each supplier would be identified only by identification symbol.

The calendar designs are communicated 42 to the calendar printer where the calendars are printed 50.

Printed calendars are conveyed 52 to the distributor 60 whose advertisement appears in the calendar.

Finally, the calendars are distributed 62 by the distributor to his or her retail customers 70 who use the calendars to obtain information on the supplier's products available through the distributor.

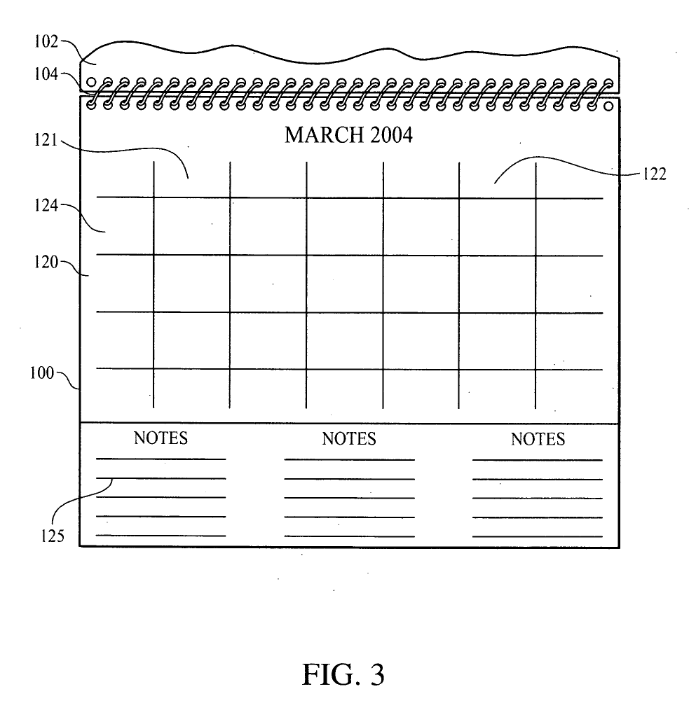

FIG. 3 is a plan view of a representative calendar showing a product planner sheet. The product planner sheet 120 is attached by a spiral binding 104 to the remaining sheets of the calendar 100. The primary advertisement 102 sheet is visible in FIG. 3. The product planner sheet comprises a grid with 12 vertical columns, for example 122, each vertical column labeled at the top with the names of the months of a year, from January at the left-most column 121 to December at the right most column 122. The horizontal rows of the grid, for example 124 are labeled on the left side with the names of product planning elements, for example, Event (the name of the product promotion event); Date of Event; Merchandise in Hand Date; Contact Distributor Date; Promotional Products; Purpose; Quantity; and Budget. Space at the bottom of the planner 125 is provided for notes. The product planner sheet is used by the retail customer as an aid in planning promotional programs throughout a coming year.

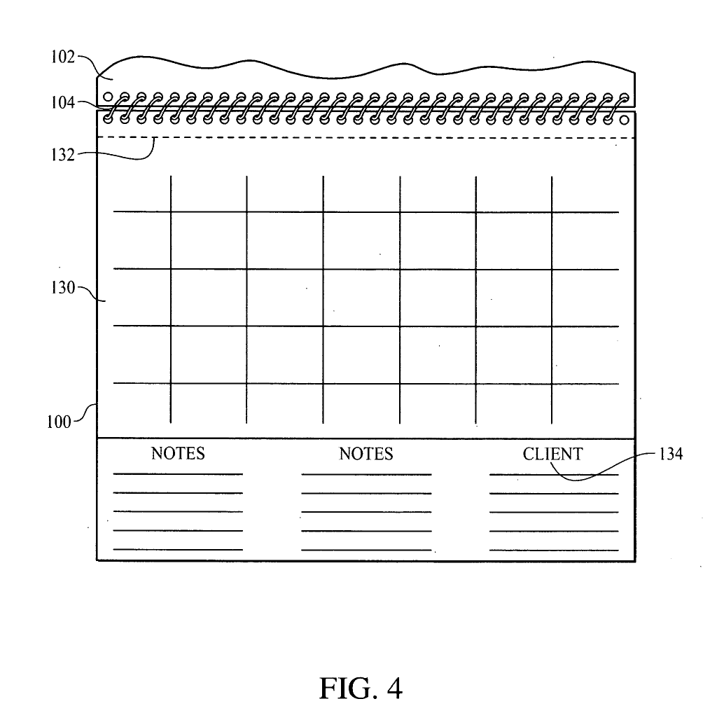

FIG. 4 is a plan view of a representative calendar showing a distributor product planner sheet 130. The distributor product planner sheet is identical to the product planner sheet in FIG. 3 with the following exceptions. The distributor product planner sheet 130 has a scored line 132 at the top which allows easy detachment of the sheet from the calendar. In addition, there is an area 134 at the bottom of the sheet for information concerning the retail customer, such as name, address, telephone numbers, e-mail addresses. The distributor product planner sheet is for use by a distributor while meeting with the client and assisting the client in planning the year's promotional program.

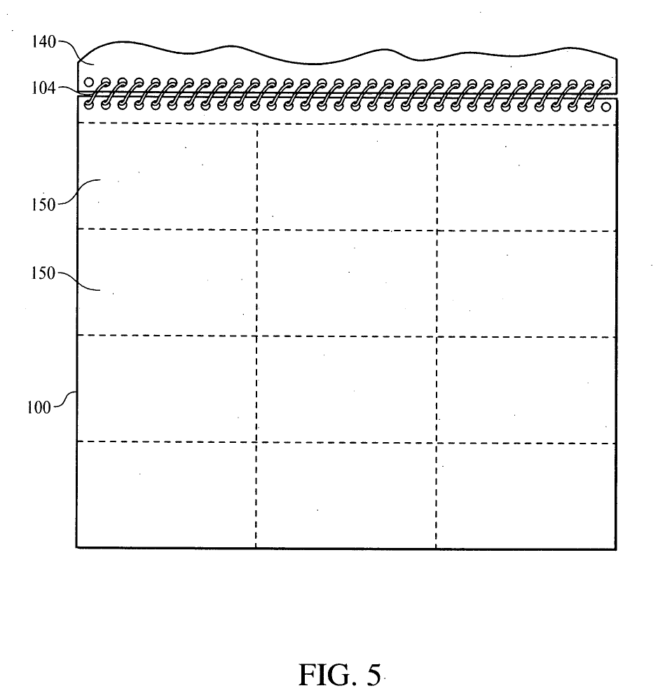

FIG. 5 is a plan view of a representative calendar showing a detachable coupon sheet 150. The detachable coupon sheet 150 is attached by a spiral binding 104 to the remaining sheets of the calendar 100. The primary advertisement 102 sheet is visible in FIG. 5. The detachable coupon sheet 150 is comprised of coupons, for example 152, with scored borders which may be detached and submitted to the distributors for special offers. The coupons may be printed on one or both sides.

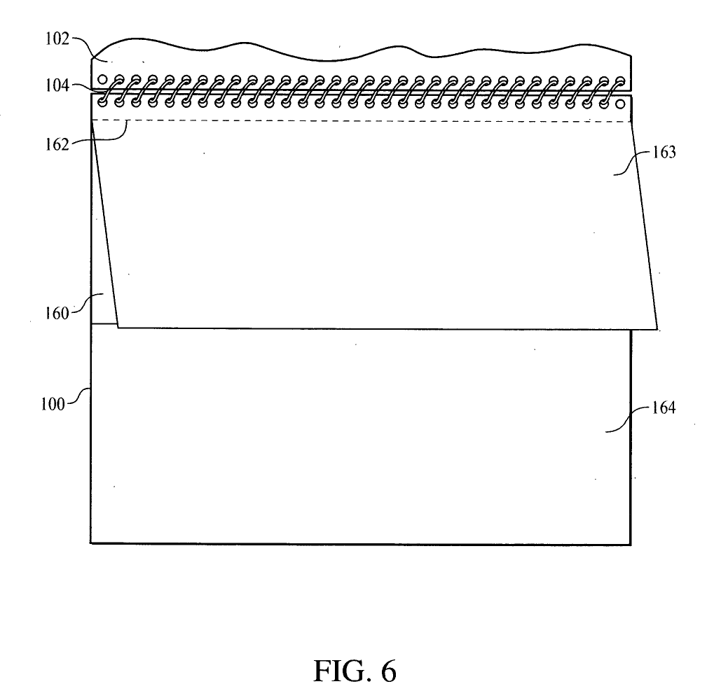

FIG. 6 is a plan view of a representative calendar showing a detachable return envelope 160. The detachable return envelope 160 is attached by a spiral binding 104 to the remaining sheets of the calendar 100. The primary advertisement 102 sheet is visible in FIG. 6. The detachable return envelope 160 has a scored line 162 which allows easy removal of the envelope from the calendar. In this example, the scored line 162 is above the envelope flap 163 which is folded down to cover the container portion 164 of the envelope. The detachable return envelope may be used by the retail customer to submit orders or inquiries or coupons to the distributor.

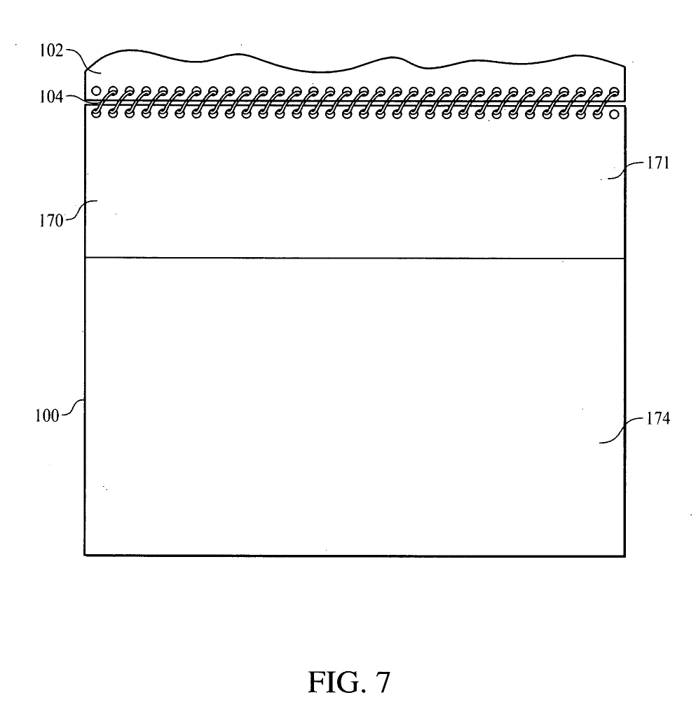

FIG. 7 is a plan view of a representative calendar showing a storage envelope 170. The storage envelope 170 is attached by a spiral binding 104 to the remaining sheets of the calendar 100. The primary advertisement 102 sheet is visible in FIG. 7. The container portion 174 of the storage envelope 170 is attached by a sheet of paper or web 171 to the spiral binding 104. The storage envelope may be used by the customer for storage of notes, invoices, etc.

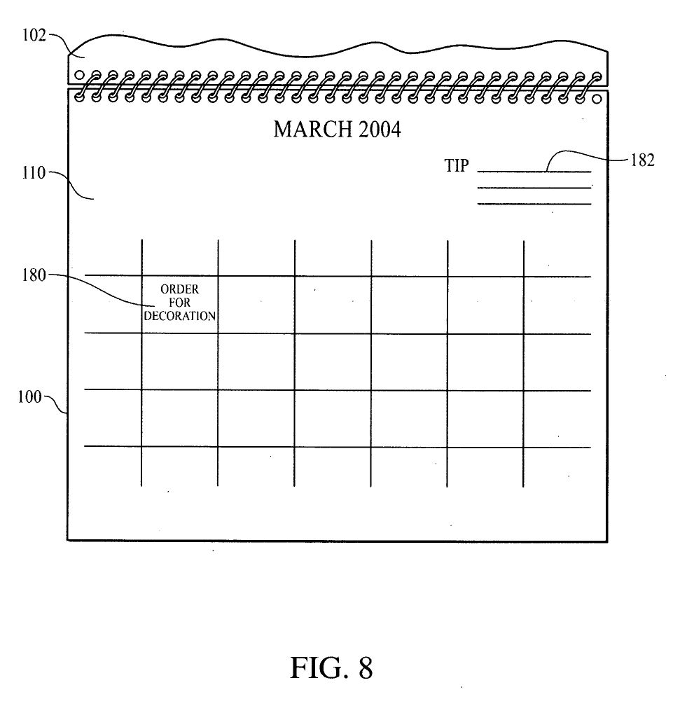

FIG. 8 is a plan view of a representative calendar showing a date sheet as in FIG. 1 which has a tickler 180 in one of the date squares. A tickler is a notation which reminds the customer of a future deadline. For example, promotional products for use in a Memorial Day promotion might require a 90 day lead time; a tickler on the calendar at the appropriate time would provide a reminder that the retail customer should act in order to obtain the promotional products at the appropriate time. A tickler may be placed anywhere on the date sheet. A “tip of the month” business advice paragraph 182 may be placed anyplace on the date sheet.

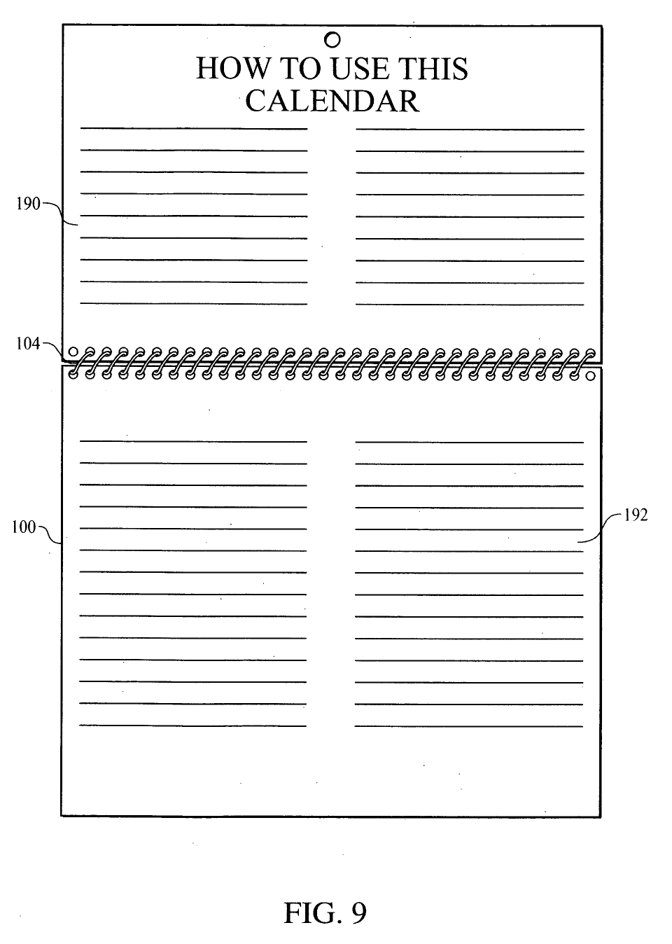

FIG. 9 is a plan view of a representative calendar showing a general information sheet 190. The general information sheet 190 is attached by a spiral binding 104 to the remaining sheets of the calendar 100. A second information sheet 192 may also be used. The general information sheet is used to provide information to the retail customer for the most efficient use of the calendar.

The Examples in this application describe a calendar with a spiral binding. Any suitable binding system for attaching sheets of paper may be used, such as sewing, stapling, or gluing.

It will be apparent to those skilled in the art that the examples and embodiments described herein are by way of illustration and not of limitation, and that other examples may be used without departing from the spirit and scope of the present invention, as set forth in the appended claims.

1. A calendar for the use of a retail customer comprising:
a multiplicity of date sheets,
an advertisement of a supplier for products manufactured or distributed by the suppliers, and
an advertisement of a distributor for services provided by the distributor in ordering custom products from a supplier for a retail customer,
wherein the supplier and distributor are both members of a restricted constituency, and the retail customer is not a member of a restricted constituency,
the calendar contains accessible information which allows contact between the distributor and retail customer,
the calendar does not contain accessible information which allows contact between the supplier and the retail customer, and
the calendar identifies the suppliers only by identifying symbols which allow the distributor to identify the supplier.

2. The calendar of claim 1 further comprising a product planner sheet.

3. The calendar of claim 1 further comprising a detachable distributor planning sheet.

4. The calendar of claim 1 further comprising a sheet of detachable coupons.

5. The calendar of claim 1 further comprising a detachable envelope.

6. The calendar of claim 1 further comprising a hanging pocket.

7. The calendar of claim 1 further comprising an information page.

8. The calendar of claim 1 further comprising tickler entries on the date sheets.

9. The calendar of claim 1 further comprising the address on an international computer network for a retail customer-friendly website on the supplier advertisement.

10. The calendar of claim 1 further comprising a business advice paragraph on a date sheet.

11. The process of producing calendars in which both the suppliers who advertise in the calendars and the distributors of the calendars to retail customers are both members of a limited constituency, comprising the steps;
a. soliciting advertisements and suppliers' promotional offers from suppliers who are members of the limited constituency,
b. soliciting advertisements from a distributor, who is a member of the limited constituency,
c. combining the advertisements and suppliers' promotional offers into printed calendars,
d. printing the calendars, wherein the calendars comprise accessible information about the distributor and only identifying symbols Xs about the suppliers, and
e. selling the printed calendars to the distributor who is a member of the limited constituency.

12. The process of claim 11 further comprising the step:
f. distributing the calendars by the distributor to the customers and prospective customers of the distributor.

13. The process of claim 11 further comprising before step c. the step:
b1. soliciting a retail customer-friendly website from a distributor, wherein the website contains information concerning the suppliers' products and promotions, accessible information about the distributor, and identifying symbols about the suppliers.

14. The process of claim 11 further comprising before step c. the step:
b2. soliciting a retail customer-friendly website from a distributor, wherein the website contains information concerning the suppliers' products and promotions, and identifying symbols about the suppliers.

15. The process of claim 11 wherein the promotional offers are money off coupons.

16. The process of producing calendars in which both the suppliers who advertise in the calendars and the distributors of the calendars to retail customers are both members of a limited constituency, comprising the steps;
a. soliciting advertisements from suppliers who are members of the limited constituency,
b. soliciting advertisements and promotional offers from a distributor who is a member of the limited constituency,
c. combining the advertisements and distributor's promotional offers into printed calendars,
d. printing the calendars, wherein the calendars comprise accessible information about the distributor and only identifying symbols about the suppliers, and
e. selling the printed calendars to the distributor who is a member of the limited constituency.

17. The process of claim 16 further comprising the step:
f. distributing the calendars by the distributor to the customers and prospective customers of the distributor.

18. The process of claim 16 further comprising before step c. the step:
b1. soliciting a retail customer-friendly website from a distributor, wherein the website contains information concerning the suppliers' products and promotions, accessible information about the distributor, and identifying symbols about the suppliers.

19. The process of claim 16 further comprising before step c. the step:
b2. soliciting a retail customer-friendly website from a distributor, wherein the website contains information concerning the suppliers' products and promotions and identifying symbols about the suppliers.

20. The process of claim 16 wherein the promotional offers are money off coupons.
